(19) United States
(12) Patent Application Publication
(10) Pub. No.: US 2026/0257602 A1
(43) Pub. Date: Sep. 3, 2026

(54) TRIM COVER AND VEHICLE SEAT

(71) Applicants: NHK SPRING CO., LTD., Yokohama-shi (JP); SUBARU CORPORATION, Tokyo (JP)

(72) Inventors: Hideki HASUMI, Yokohama-shi (JP); Yuuta Yamada, Yokohama-shi (JP); Kazuyoshi Nishigaki, Yokohama-shi (JP); Yosuke Ishiyama, Tokyo (JP); Masato Fukushima, Tokyo (JP)

(21) Appl. No.: 19/553,708

(22) Filed: Mar. 2, 2026

(30) Foreign Application Priority Data
Mar. 3, 2025 (JP) 2025-033234

(51) Int. Cl. B60N 2/58; B60N 2/90

(52) U.S. Cl. CPC B60N 2/58; B60N 2/90

(57) ABSTRACT

A pocket cloth piece forms a back face pocket. A pocket entry of a back face pocket is partitioned left and right by part of an upper edge portion of the pocket cloth piece being sewn to the cover main body at a sewn portion. A bag section having a bag shape provided at the upper edge portion is partitioned by the sewn portion into a left side bag portion and a right side bag portion. A reinforcement member includes a strip-shaped portion having a strip shape and a rod-shaped portion having a rod shape fixed to a width direction one-end portion of the strip-shaped portion, and is housed inside the bag section in an orientation in which the rod-shaped portion is positioned at the seat upper side with respect to the strip-shaped portion, with the strip-shaped portion sewn to the bag section at the sewn portion.

### CROSS-REFERENCE TO RELATED APPLICATION

This application is based on and claims priority under 35 USC 119 from Japanese Patent Application No. 2025-033234 filed on March 3, 2025, the disclosure of which is incorporated by reference herein.

### BACKGROUND

### Technical Field

The present disclosure relates to a vehicle seat, and in particular to a trim cover of a seatback.

### Related Art

Japanese Utility Application Publication No. H4-7243 discloses the insertion of a core into a bag section of an upper edge of a back face pocket of a seatback.

Japanese Patent No. 6985819 discloses a configuration in which an entry to a back face pocket of a seatback (a pocket entry) is partitioned left and right by a fastener.

### SUMMARY

In the related art disclosed in Japanese Utility Application Publication No. H4-7243, unwanted gaping open of the back face pocket cab be prevented by the core. Regarding this point, in a back face pocket having a pocket entry partitioned left and right by a fastener as in the related art disclosed in Japanese Patent No. 6985819, because the core inserted into the upper edge of the bag section is divided left and right, sometimes creases occur on the back face pocket.

An object of the present disclosure is to obtain a trim cover and a vehicle seat that are able to prevent or suppress creases from occurring on a back face pocket with a pocket entry partitioned left and right.

A trim cover of a first aspect of the present disclosure includes a cover main body covering a pad of a seatback, a pocket cloth piece that is provided at a back face of the seatback, that together with the cover main body forms a back face pocket opening toward a seat upper side, with a pocket entry of the back face pocket partitioned left and right by part of an upper edge portion of the pocket cloth piece being sewn to the cover main body at a sewn portion, and with a bag section having a bag shape provided at the upper edge portion being partitioned by the sewn portion into a left side bag portion and a right side bag portion, and a reinforcement member that includes a strip-shaped portion having a strip shape and a rod-shaped portion having a rod shape fixed to a width direction one-end portion of the strip-shaped portion, and that is housed inside the bag section in an orientation in which the rod-shaped portion is positioned at the seat upper side with respect to the strip-shaped portion, with the strip-shaped portion sewn to the bag section at the sewn portion.

In the trim cover of the first aspect, the cover main body covers the seatback pad, and the pocket cloth piece provided at the back face of the seatback, together with the cover main body, forms the back face pocket opening toward the seat upper side. Part of the upper edge portion of the pocket cloth piece is sewn to the cover main body at the sewn portion. The pocket entry of the back face pocket is partitioned left and right thereby. The bag section having a bag shape is provided at the upper edge portion of the pocket cloth piece. The bag section is partitioned by the sewn portion into the left side bag portion and the right side bag portion. A reinforcement member is housed inside the bag section. The reinforcement member includes the strip-shaped portion having a strip shape and the rod-shaped portion having a rod shape fixed to a width direction one-end portion of the strip-shaped portion, and is housed inside the bag section in an orientation in which the rod-shaped portion is positioned at the seat upper side with respect to the strip-shaped portion. The rigidity of this reinforcement member enables creases to be prevented or suppressed from being generated in the back face pocket. Moreover, in this reinforcement member, the strip-shaped portion is sewn to the bag section at the sewn portion, enabling positional misalignment of the reinforcement member inside the bag section to be prevented or suppressed.

A trim cover of a second aspect is the first aspect, wherein a seat upper side portion of the rod-shaped portion is formed thicker in a seat front-rear direction than a seat lower side portion thereof.

In the trim cover of the second aspect, the rod-shaped portion is configured as described above, and so good rigidity of the upper edge portion of the pocket cloth piece can be secured by the seat upper side portion of the rod-shaped portion. Moreover, the seat lower side portion of the rod-shaped portion (namely the portion thinner in the seat front-rear direction) can be sewn to the bag section at the sewn portion, enabling the position of the rod-shaped portion to be restricted. As a result thereof, for example, abnormal noise can be prevented from occurring.

A trim cover of a third aspect it the first aspect or the second aspect, further including a left and right pair of cores that are each formed in a plate shape and are respectively housed inside the left side bag portion and the right side bag portion at a seat lower side of the rod-shaped portion.

In the trim cover of the third aspect, the left and right pair of cores that are each formed in a plate shape are respectively housed inside the left side bag portion and the right side bag portion of the pocket cloth piece at the seat lower side of the rod-shaped portion. The position of the rod-shaped portion can be restricted by the pair of cores.

A trim cover of a fourth aspect is the third aspect, wherein the strip-shaped portion covers the left and right pair of cores from a seat rear side.

In the trim cover of the fourth aspect, the left and right pair of cores are covered from the seat rear side by the strip-shaped portion of the reinforcement member, enabling highlights of the cores to be prevented or suppress from appearing at the surface of the bag section of the pocket cloth piece.

A vehicle seat of a fifth aspect includes a seat cushion for an occupant of a vehicle to sit on, and a seatback to support a back of the occupant that includes a pad covered by the cover main body of the trim cover of any one aspect of the first aspect to the fourth aspect.

In the vehicle seat of the fifth aspect, the back of an occupant seated on the seat cushion is supported by the seatback. The pad of the seatback is covered by the cover main body of the trim cover. The trim cover is a trim cover of one aspect of the first aspect to the fourth aspect, and so exhibits the advantageous effect described above.

As described above, the trim cover and vehicle seat according to the present disclosure are able to prevent or suppress creases from being generated in a back face pocket having a left and right partitioned pocket entry.

### BRIEF DESCRIPTION OF THE DRAWINGS

Exemplary embodiments of the present invention will be described in detail based on the following figures, wherein:

FIG. 1 is a perspective view illustrating a vehicle seat including a trim cover according to an exemplary embodiment;

FIG. 2 is a back face view illustrating part of a trim cover according to an exemplary embodiment;

FIG. 3 is a front view illustrating a reinforcement member for providing to a trim cover according to an exemplary embodiment;

FIG. 4 is a first back face view corresponding to FIG. 2 and illustrating a state partway through manufacture of a trim cover according to an exemplary embodiment;

FIG. 5 is a second back face view corresponding to FIG. 2 and illustrating a state partway through manufacture of the trim cover according to the exemplary embodiment;

FIG. 6 is a back face view illustrating part of a trim cover according to a first comparative example; and

FIG. 7 is a back face view illustrating part of a trim cover according to a second comparative example.

### DETAILED DESCRIPTION

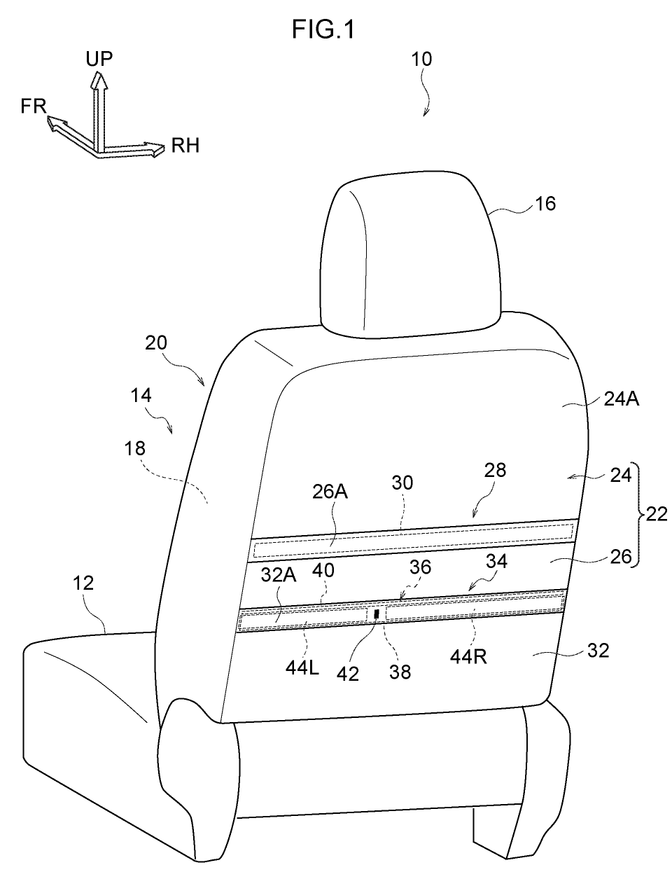

Description follows regarding a trim cover 20 according to an exemplary embodiment of the present disclosure, with reference to FIG. 1 to FIG. 5. Note that sometimes some of the reference numerals are omitted in order to improve clarity of the drawings. Moreover, as appropriate in the drawings, arrows FR, RH, and UP respectively indicate forward, rightward, and upward directions of a vehicle seat 10 provided with a trim cover 20 according to the present exemplary embodiment. Hereinafter, when reference is simply given to front and rear, left and right, and up and down in the following description then this indicates directions with respect to the vehicle seat 10.

As illustrated in FIG. 1, the vehicle seat 10 provided with the trim cover 20 according to the present exemplary embodiment includes a seat cushion 12 for an occupant to sit on, a seatback 14 for supporting the back of the occupant, and a headrest 16 for supporting the head of the occupant. The vehicle seat 10 is, as an example, a vehicle front seat. The seat cushion 12 is coupled to a floor section of a vehicle body through a non-illustrated seat sliding mechanism. A lower end portion of the seatback 14 is coupled to a rear end portion of the seat cushion 12 through a non-illustrated reclining mechanism. The headrest 16 is coupled to an upper end portion of the seatback 14 so as to be adjustable in height position.

The trim cover 20 configuring a cover of the seatback 14 covers a pad 18 configuring a cushion material of the seatback 14, and the pad 18 is attached to a non-illustrated frame configuring framework of the seatback 14. The frame is, for example, configured by joining together press-formed metal plate blanks and bend-processed metal pipe material. The pad 18 is, for example, configured from a foam body such as a urethane foam or the like, and covers the frame from above.

The trim cover 20 includes a cover main body 22, a second pocket cloth piece 32, a suspender 36, which is a reinforcement member, a first core 30, and a left-right pair of second cores 44L, 44R. The cover main body 22 is, as an example, configured by a bag-shaped cover 24, and a first pocket cloth piece 26. The second pocket cloth piece 32 corresponds to a “pocket cloth piece” of the present disclosure, and the left and right pair of second cores 44L, 44R correspond to a “left and right pair of cores” of the present disclosure.

The bag-shaped cover 24 is, for example, formed in a bag shape by sewing together plural cloth pieces (covering material) made from fabric material, leather, synthetic leather, or the like, and is covered over the pad 18 from the upper side thereof. A first pocket cloth piece 26 is attached to a lower portion of a back face section 24A configuring the back face of the seatback 14.

The first pocket cloth piece 26 is configured from cloth pieces similar to the plural cloth pieces configuring the bag-shaped cover 24, and is formed in a rectangular shape having a long side along the left-right direction when viewed along the front-rear direction. Both left and right edge portions and a lower edge portion of the first pocket cloth piece 26 are sewn to the bag-shaped cover 24. The first pocket cloth piece 26 accordingly forms a first back face pocket 28 having an upward facing opening between itself and the bag-shaped cover 24. Small items and the like can be housed at the inside of the first back face pocket 28.

The upper edge portion of the first pocket cloth piece 26 is folded in two and sewn together such that a first bag section 26A is formed in a tube shape extending along the left-right direction. A first core 30 is housed in (inserted into) the first bag section 26A. The first core 30 is, for example, configured by a resin, and is formed in an elongated flat plate shape. The first core 30 is arranged inside the first bag section 26A in an orientation in which its length direction is along the left-right direction and its plate thickness direction is along the front-rear direction. The second pocket cloth piece 32 is arranged at a rear side of the first pocket cloth piece 26.

The second pocket cloth piece 32 is configured from cloth pieces similar to the plural cloth pieces configuring the bag-shaped cover 24, and is formed in a rectangular shape having a long side along the left-right direction when viewed along the front-rear direction. A width dimension of the second pocket cloth piece 32 is set smaller in the height direction than the width dimension of the first pocket cloth piece 26 in the height direction, and the second pocket cloth piece 32 is superimposed on a lower section of the first pocket cloth piece 26 from the rear side.

Both left and right edge portions and a lower edge portion of the second pocket cloth piece 32 are sewn to the bag-shaped cover 24 and the first pocket cloth piece 26. The second pocket cloth piece 32 accordingly forms a second back face pocket 34 with an upward facing opening between itself and the first pocket cloth piece 26 (namely, between itself and the cover main body 22). Small items and the like can be housed at the inside of the second back face pocket 34. The second back face pocket 34 corresponds to a “back face pocket” of the present disclosure.

Note that although in the present exemplary embodiment the cover main body 22 is configured from the bag-shaped cover 24 and the first pocket cloth piece 26, a configuration omitting the first pocket cloth piece 26 (namely, in which the cover main body 22 is configured from the bag-shaped cover 24 alone) may be adopted.

An upper edge portion of the second pocket cloth piece 32 is folded in two and sewn together, such that a second bag section 32A is formed in a tube shape extending along the left-right direction. The second bag section 32A corresponds to a “bag section” of the present disclosure. A suspender 36 is housed in (inserted into) the second bag section 32A.

The suspender 36 is something that is also called a slit cord, hanger member, or the like and, as illustrated in FIG. 3, includes a strip-shaped portion 38 formed in an elongated strip shape, and a rod-shaped portion 40 formed in an elongated rod shape fixed to a width direction one-end portion of the strip-shaped portion 38. The strip-shaped portion 38 is, for example, configured from a cloth-form material such as a non-woven fabric or the like, and the rod-shaped portion 40 is configured from a resin. Note that reference to “reinforcement member” in the present disclosure is not limited to being the suspender 36, and may be any rod-shaped portion fixed to a width direction one-end portion of the strip-shaped portion.

The suspender 36 is housed inside the second bag section 32A in an orientation in which the rod-shaped portion 40 is positioned at the upper side of the strip-shaped portion 38. The rod-shaped portion 40 has an arrow shaped cross-section when viewed along its length direction (the left-right direction), with an arrowhead portion 40A, which is a portion at the upper side thereof, formed with a thickness in the front-rear direction that is thicker than an integrally molded portion 40B, which is a portion at the lower side thereof. The integrally molded portion 40B is integrally molded to the strip-shaped portion 38.

A portion at a left-right direction intermediate part of the second bag section 32A (namely, the upper edge portion of the second pocket cloth piece 32) having the suspender 36 inserted inside is sewn to the first pocket cloth piece 26 (namely, to the cover main body 22) at a sewn portion 42. This means that the pocket entry (opening section) of the second back face pocket 34 is partitioned left and right, and the second bag section 32A is partitioned by the sewn portion 42 into a left side bag portion 32AL and a right side bag portion 32AR. In the sewn portion 42, the strip-shaped portion 38 of the suspender 36 and part of the integrally molded portion 40B are sewn to the second bag section 32A. The sewn portion 42 is, for example, configured as a ring of stitching using an embroidery thread. Note that a configuration may be adopted in which part of the integrally molded portion 40B of the sewn portion 42 is not sewn to the second bag section 32A (namely, a configuration in which part of the strip-shaped portion 38 alone is sewn to the second bag section 32A).

Second cores 44L, 44R are respectively housed in (inserted into) the left side bag portion 32AL and the right side bag portion 32AR. These second cores 44L, 44R are formed in elongated flat plate shapes, and are arranged inside the left side bag portion 32AL and the right side bag portion 32AR in orientations in which their length directions are along the left-right direction, and their plate thickness directions are along the front-rear direction. These second cores 44L, 44R are arranged at a lower side of the rod-shaped portion 40, and are also arranged at the front side of the strip-shaped portion 38 so as to be covered by the strip-shaped portion 38 from the rear side.

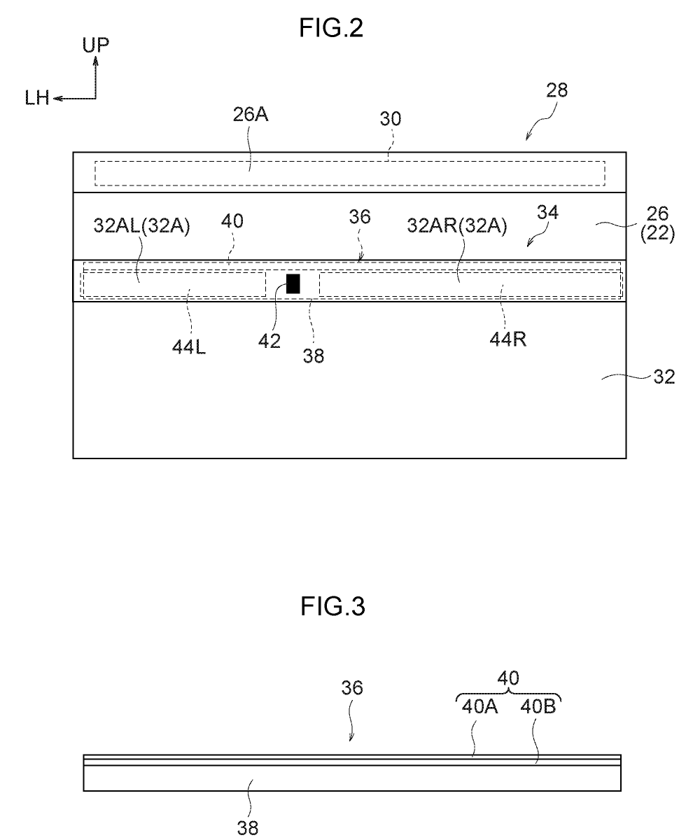

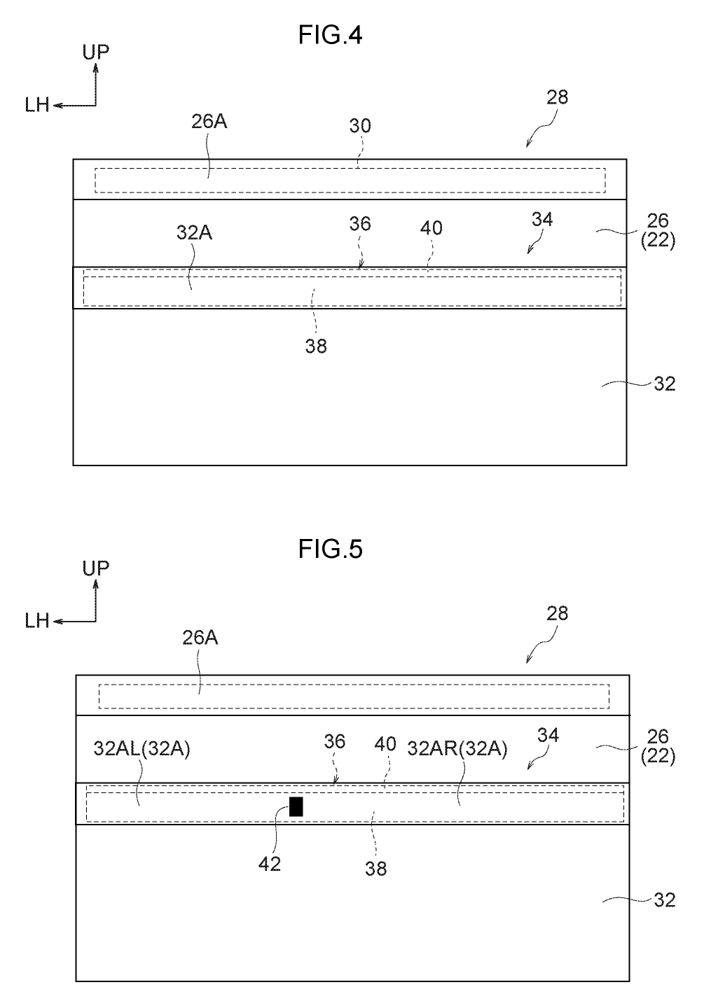

When manufacturing the second back face pocket 34 during manufacture of the trim cover 20 configured as described above, firstly, as illustrated in FIG. 4, the suspender 36 is inserted inside the second bag section 32A of the second pocket cloth piece 32. Next, as illustrated in FIG. 5, sewing of the sewn portion 42 is performed. The second cores 44L, 44R are then configured respectively inserted inside the left side bag portion 32AL and inside the right side bag portion 32AR, as illustrated in FIG. 2.

Next, description follows regarding operation and advantageous effects of the present exemplary embodiment.

In the vehicle seat 10 configured as described above, the back of an occupant seated on the seat cushion 12 is supported by the seatback 14. The pad 18 of the seatback 14 is covered by the cover main body 22 of the trim cover 20. In the trim cover 20, the second pocket cloth piece 32 provided at the back face of the seatback 14, together with the cover main body 22, forms the second back face pocket 34 with the upward facing opening.

Part of an upper edge portion of the second pocket cloth piece 32 is sewn to the cover main body 22 at the sewn portion 42. The pocket entry of the second back face pocket 34 is accordingly partitioned left and right. The second bag section 32A having a bag shape is provide to the upper edge portion of the second pocket cloth piece 32. The second bag section 32A is partitioned by the sewn portion 42 into the left side bag portion 32AL and the right side bag portion 32AR. The suspender 36 is housed inside the second bag section 32A.

The suspender 36 includes the strip-shaped portion 38 and the rod-shaped portion 40 having a rod shape fixed to the width direction one-end portion of the strip-shaped portion 38, and is housed inside the second bag section 32A oriented with the rod-shaped portion 40 positioned at the upper side with respect to the strip-shaped portion 38. Creases can be prevented or suppressed from occurring in the second back face pocket 34 due to the rigidity of the suspender 36. Moreover, in the suspender 36, the strip-shaped portion 38 is sewn to the second bag section 32A of the sewn portion 42, thereby enabling positional misalignment to be prevented or suppressed of the suspender 36 inside the second bag section 32A.

Moreover, in the present exemplary embodiment, the left and right pair of second cores 44L, 44R are each formed in a plate shape and are respectively housed inside the left side bag portion 32AL and the right side bag portion 32AR at the lower side of the rod-shaped portion 40 of the suspender 36. The position of the rod-shaped portion 40 can be restricted by these two second cores 44L, 44R.

Furthermore, in the present exemplary embodiment, the left and right pair of second cores 44L, 44R are covered from the rear side by the strip-shaped portion 38 of the suspender 36. This thereby enables highlights of the second cores 44L, 44R (i.e. portions of the surface of the second bag section 32A where light is strongly reflected) to be prevented or suppressed from occurring at parts of the surface of the second bag section 32A. Moreover, the rod-shaped portion 40 of the suspender 36 can be prevented from contacting the second cores 44L, 44R by the strip-shaped portion 38, enabling the prevention of abnormal noise occurring due to such contact.

Moreover, in the present exemplary embodiment, the arrowhead portion 40A at the upper side of the rod-shaped portion 40 of the suspender 36 is formed thicker in the front-rear direction than the integrally molded portion 40B at the lower side thereof. This thereby enables good rigidity of the upper edge portion of the second pocket cloth piece 32 to be secured by the arrowhead portion 40A. Moreover, the integrally molded portion 40B is sewn to the second bag section 32A of the sewn portion 42, enabling the position of the rod-shaped portion 40 to be restricted effectively. Due to being able to accordingly prevent contact between the rod-shaped portion 40 and the second cores 44L, 44R, abnormal noise can be prevented from occurring due to such contact.

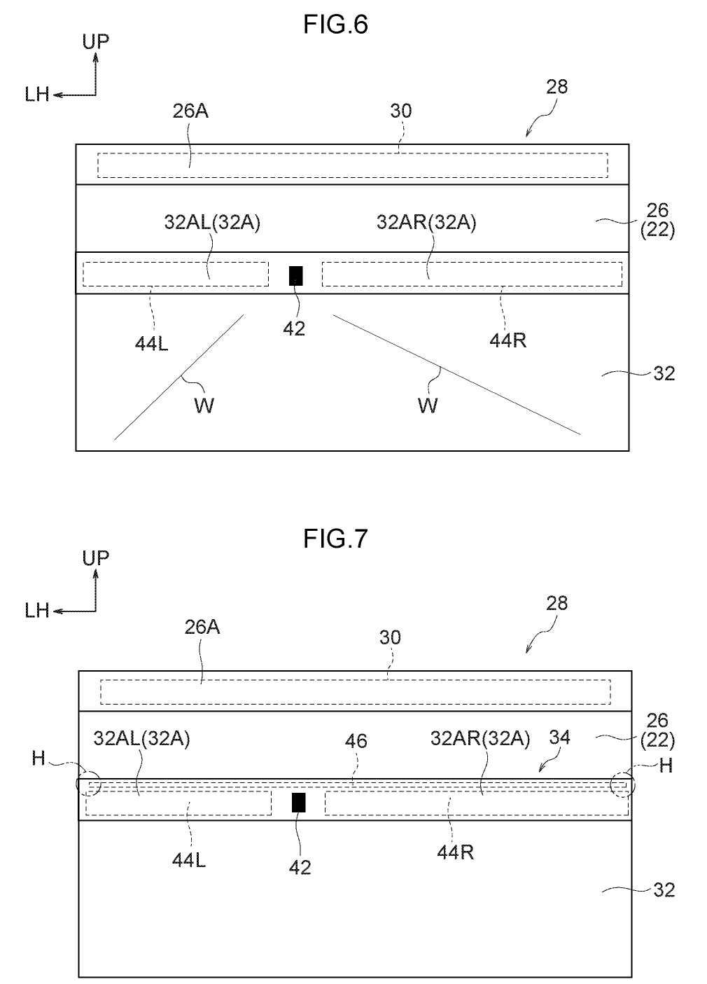

Supplementary description follows regarding the above advantageous effects, with reference to a first comparative example illustrated in FIG. 6 and a second comparative example illustrated in FIG. 7. The first comparative example is configured the same as the present exemplary embodiment, except in that there is no suspender 36 housed inside the second bag section 32A. In the first comparative example, the second cores 44L, 44R are divided left and right, and so creases W1, W2 such as those illustrated in FIG. 6 occur on the surface of the second pocket cloth piece 32, and also the second back face pocket 34 gapes open when objects are placed inside and taken out of the second back face pocket 34.

On the other hand, in the second comparative example, a wire 46 is inserted inside the second bag section 32A instead of the suspender 36, enabling prevention of the generation of creases W1, W2 and gaping open such as in the first comparative example. However, highlights are generated on the surface of the second bag section 32A in the vicinity of end portions of the wire 46 (see Hs of FIG. 7), and the wire 46 and the second cores 44L, 44R contact each other and generate abnormal noise. Furthermore, when the wire 46 is being inserted inside the second bag section 32A and the like, rust prevention oil adhered to the wire 46 might adhere to the surface of the second pocket cloth piece 32 and the like, resulting in effort being incurred to wipe this off beforehand. Regarding this point, employing the suspender 36 in the present exemplary embodiment enables the elimination of the above described gaping open, highlights, occurrence of abnormal noise, and rust prevention oil adherence.

Note that although the present exemplary embodiment was configured with the second cores 44L, 44R respectively inserted inside the left side bag portion 32AL and the right side bag portion 32AR of the second bag section 32A, there is no limitation thereto, and a configuration that omits the second cores 44L, 44R may be adopted. In such cases too, the rigidity of the upper edge portion of the second pocket cloth piece 32 can be secured by the suspender 36. Moreover, the prevention of abnormal noise and highlights from occurring is easier, and manufacture of the trim cover 20 is easier, than in a configuration in which plural components are inserted inside the second bag section 32A.

Moreover, although the present exemplary embodiment has been described for a case in which the present disclosure is applied to a vehicle seat, the present disclosure is applicable to a seat used in transportation other than a vehicle (for example in an aircraft or boat).

Various other modifications may be implemented within a range not departing from the spirit of the present disclosure. Moreover, obviously the scope of rights of the present disclosure is not limited to the above exemplary embodiments.

What is claimed is:

1. A trim cover comprising:
a cover main body covering a pad of a seatback;
a pocket cloth piece that is provided at a back face of the seatback, that together with the cover main body forms a back face pocket opening toward a seat upper side, with a pocket entry of the back face pocket partitioned left and right by part of an upper edge portion of the pocket cloth piece being sewn to the cover main body at a sewn portion, and with a bag section having a bag shape provided at the upper edge portion being partitioned by the sewn portion into a left side bag portion and a right side bag portion; and
a reinforcement member that includes a strip-shaped portion having a strip shape and a rod-shaped portion having a rod shape fixed to a width direction one-end portion of the strip-shaped portion, and that is housed inside the bag section in an orientation in which the rod-shaped portion is positioned at the seat upper side with respect to the strip-shaped portion, with the strip-shaped portion sewn to the bag section at the sewn portion.

2. The trim cover of claim 1, wherein a seat upper side portion of the rod-shaped portion is formed thicker in a seat front-rear direction than a seat lower side portion thereof.

3. The trim cover of claim 1, further comprising a left and right pair of cores that are each formed in a plate shape and are respectively housed inside the left side bag portion and the right side bag portion at a seat lower side of the rod-shaped portion.

4. The trim cover of claim 3, wherein the strip-shaped portion covers the left and right pair of cores from a seat rear side.

5. A vehicle seat comprising:
a seat cushion for an occupant of a vehicle to sit on; and
a seatback for supporting a back of the occupant that includes a pad covered by the cover main body of the trim cover of claim 1.
